(19) United States
(12) Patent Application Publication
(10) Pub. No.: US 2011/0189483 A1
(43) Pub. Date: Aug. 4, 2011

(54) Gram-Scale Synthesis of Well-Defined Gold Nanorods

(75) Inventors: Eugene R. Zubarev, Houston, TX (US); Bishnu P. Khanal, Houston, TX (US)

(73) Assignee: Williams Marsh Rice University, Houston, TX (US)

(21) Appl. No.: 12/595,705

(22) PCT Filed: Apr. 16, 2008
(86) PCT No.: PCT/US2008/060470

§ 371 Date: Apr. 21, 2011

Related U.S. Application Data
(60) Provisional application No. 60/925,586, filed on Apr. 20, 2007.

(51) Int. Cl. C22C 5/02; B22F 9/18; B32B 5/16

(52) U.S. Cl. 428/402; 75/370; 420/507

(57) ABSTRACT

A method of making gold nanorods wherein the total mass of gold nanorods is more than one gram includes (1) adding a seed solution containing gold nanostructures and/or residual NaBH4 reducing agent to an aqueous growth solution to form a nanorod solution; and (2) adding ascorbic acid solution slowly in small incremental portions to the nanorod solution. Gold nanorods made by this process according have an aspect ratio typically from about 1.1 to about 100, an average diameter in a range from about 5-50 nm, and an average length in a range from about 50 to about 200 nm.

### BACKGROUND

It is well established that nanostructures frequently exhibit properties substantially different from the corresponding bulk material. At the nanometer scale, changes in properties are influenced strongly by shape and size of the nanostructure. This is especially true for nanostructures having large aspect ratios such as nanorods, which can differ quite significantly in diameter and length.

Gold nanorods, in particular, have a strong absorption band in a region extending from visible light to the near infrared, and it is possible to change its absorption maxima position by controlling configuration. Gold nanorods have utility as near-infrared probes because modification of their surface enables changes in their physical properties.

Several methods are available for the manufacture of gold nanorods including electrolytic, chemical reduction, and photoreduction processes. In the electrolytic method, a solution containing a cationic surfactant is electrolyzed with constant current, and gold clusters leached from a gold plate at the anode.

In one chemical reduction method, NaBH₄ reduces chlorauric acid and gold nanoparticles are generated. These gold nanoparticles act as “seed particles” and growing them in solution results gold nanorods. The length of the gold nanorods generated is influenced by the ratio of the “seed particles” to chlorauric acid in the growth solution. With the chemical reduction method, it is typically possible to generate longer gold nanorods relative to electrolytic methods.

With the photo-reduction method, chlorauric acid is added to substantially the same solution as that in the electrolytic method, and ultraviolet irradiation effects the reduction of chlorauric acid. It is generally possible to control the length of the gold nanorods by the irradiation time.

The aforementioned methods may be performed adequately on relatively small-scale (typically milligram scale) and although the need exists for a procedure to generate gram quantities of gold nanorods for industrial scale applications, none of the present processes have proven amenable to scale up. In most cases, attempts to scale up production leads to erosion of uniformity in shape and/or size of the resultant product nanorods. A need, therefore, exists for the development of such a process that is scalable without sacrificing the uniformity of the product nanorods.

### SUMMARY

In one aspect, embodiments disclosed herein relate to a method of making gold nanorods wherein the total mass of gold nanorods can be of any scale, but is especially amenable to production of multi-gram quantities without compromising uniformity in shape and size. The method includes (1) adding a seed solution containing gold nanostructures and/or sodium borohydride NaBH₄ to an aqueous growth solution to form a nanorod solution; and (2) adding ascorbic acid solution slowly in a stepwise addition to the nanorod solution. Gold nanorods made by this process have an aspect ratio typically from about 1.1 to about 10, an average diameter in a range from about 8-10 nm, and an average length in a range from about 40 to about 45 nm.

The foregoing has outlined rather broadly the features of the present disclosure in order that the detailed description that follows may be better understood. Additional features and advantages will be described hereinafter which form the subject of the claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1a shows a TEM image of gold nanorods produced by slow addition of a total of 9 mL of dilute ascorbic acid solution by “slow addition” in accordance with embodiments of the present disclosure.

FIG. 1b shows a TEM image of gold nanorods produced by slow addition of a total of 30 mL of dilute ascorbic acid solution in accordance with embodiments of the present disclosure.

FIG. 1c shows a TEM image of gold nanorods produced by slow addition of a total of 45 mL of dilute ascorbic acid solution in accordance with embodiments of the present disclosure.

FIG. 1d shows a TEM image of gold nanorods produced by addition of a total of 9 mL of dilute ascorbic acid solution by prior art methods for comparison to FIG. 1a.

FIG. 1e shows a TEM image of gold nanorods produced by slow addition of a total of 30 mL of dilute ascorbic acid solution by prior art methods for comparison to FIG. 1b.

FIG. 1f shows a TEM image of gold nanorods produced by slow addition of a total of 45 mL of dilute ascorbic acid solution by prior art methods for comparison to FIG. 1c.

FIG. 2 shows a plot of the mol percent of ascorbic acid added as a function of time.

### DETAILED DESCRIPTION

The present invention is generally directed to the scale-up manufacture of gold nanorods while controlling the uniformity in size and shape of the resultant product nanorods. The method of making gold nanorods includes (1) adding a “seed” solution comprising gold nanostructures and residual NaBH₄ used for gold reduction to an aqueous growth solution to form a nanorod solution; and (2) adding an ascorbic acid solution slowly stepwise to the nanorod solution.

In some embodiments, the aqueous growth solution includes gold (III) chloride, a surfactant, and silver nitrate. One skilled in the art will appreciate the ability to use other gold (III) salt sources. The surfactant is generally any quaternary ammonium salt, although it is preferable to have long chain alkyl substituents as at least one of the alkyl groups on the nitrogen of the ammonium salt. Exemplary surfactants include, for example, cetyltrimethylammonium bromide (CTAB).

The slow stepwise addition of the ascorbic acid solution can be carried out by addition of increasingly concentrated aliquots from about 2 to about 35 mol % ascorbic acid, based on gold (III) chloride, until a substantially stoichiometric amount of ascorbic acid, based on gold (III) chloride, has been added. During the process, when the concentration of remaining gold becomes sufficiently low, ascorbic acid may be added in larger portions because the effective concentration of gold ion is low enough to prevent new seeding which would disturb the uniformity of the nanorods being grown.

An important element of this procedure is the slow rate of addition of the dilute ascorbic acid aliquots. For example, a period of time from about 1 hour to 4 hours can separate the addition of each aliquot, especially in the early stages of nanorod amplification. The slow addition is especially beneficial in the early stages of nanorod growth when the concentration of gold is sufficiently high to cause the formation of new nucleated particles that may begin new rod growth, or cause anomalous growth by branching off the side of an existing nanorod. Applicants have made the qualitative observation that the quality of nanorod product, i.e. the uniformity in size and shape distribution, is proportional to the addition times between the aliquots of ascorbic acid. That is better uniformity in shape and size is realized with longer times between introduction of ascorbic acid aliquots. The length of time of between aliquots may be guided by practical considerations such as the desired tolerances in uniformity of shape and size of the nanorods balanced with production demands. Ideally, the addition rate of ascorbic acid would be slower than x mol/hour, for modest improvements over known methods for nanorod growth.

In some embodiments, the gold nanostructures provided as the seed are themselves gold nanorods. In other embodiments, sodium borohydride may serve as the “seed” for gold nanorod production. The gold nanorods synthesized on large scale may have an average diameter in a range from about 8 to about 10 nm, an average length in a range from about 40 to about 45 nm. Such gold nanorods are attainable on at least a 1 gram scale. In some embodiments, the gold nanorods are attainable on multi-gram scale with nanorods having an aspect ratio from about 1.1 to about 100.

In one embodiment, the synthetic procedure disclosed herein laboratory gold (III) ions can be slowly reduced by ascorbic acid on top of the pre-synthesized gold nanorods prepared by a known procedure introduced by Murphy et al. (Adv. Mater. 2001, 13, 1389) and later modified by El-Sayed et al. (Chem. Mater. 2003, 15, 1957). It was found that a 100-fold increase in the amount of all the components (gold seed nanoparticles, cetyltrimethylammonium bromide (CTAB), silver nitrate, gold (III) chloride, and water) will not affect either the quality or the overall yield of the nanorods. This way the original procedure is scaled up from approximately 0.5 mg to approximately 50 mg of nanorods (100-fold increase) and the total volume of the growth solution is increased from 10 mL to 1000 mL. The nanorods formed under these conditions are typically 8-10 nm in diameter and 40-45 nm in length as confirmed by electron microscopy analysis.

Significantly, it was found that gold (III) chloride or hydrogen tetrachloroaurate (III) can be added directly into the growth solution of gold nanorods (solution also contains CTAB, silver nitrate, gold (I) ions and ascorbic acid) reduced by ascorbic acid exclusively on their surface. This way the overall number of nanorods remains roughly the same, but their mass increases about 20 times and therefore affords approximately 1 gram of gold nanorods (2000 fold increase in comparison with the original procedure), which measure 20-40 nm in diameter and 30-100 nm in length. This post-growth reduction of gold (III) ions proceeds without the formation of any new nanocrystals or spherical nanoparticles and the entire amount of gold (III) ions added to the original nanorods is converted into metallic gold deposited on their surface only. The overall yield of gold (III) to gold (0) conversion is nearly quantitative (about 100%) if a slight excess of ascorbic acid (1.1 equiv with respect to Au (III) ions) is added to the solution.

Again, it is beneficial when performing this reduction to maintain a very slow rate of addition of ascorbic acid. In preferred embodiments the ascorbic acid is added as small portions (typically as a dilute solution, for example, as an aqueous 0.0788 M solution) over a long period of time (many hours preferably). If, on the other hand, the entire 1 equiv. of ascorbic acid is added at once, the nanorods will become irregularly-shaped and nanocrystals of other random shapes will form in large quantities.

Experimental example: Typically gold ions are introduced into the growth solution of regular nanorods and age such mixtures for 2-3 hours. Then, the first (and the smallest) portion of ascorbic acid (typically only about 2 mol %) is introduced all at once upon stirring. The resulting solution is then aged for 1-4 hrs (no stirring) before the second portion of ascorbic acid is added. This second portion is slightly larger (typically about 5 mol %). After an additional 1 hour about 10 mol % of ascorbic acid is introduced. This process continues with the addition of 15, 20, 25, and 35 mol %. This slow addition of ascorbic acid (one portion at a time) proceeds typically at about room temperature, i.e. about 25-27° C. (One skilled in the art will recognize the ability to work outside this range of temperatures to effect nominally the similar results in uniformity of size and shape.) When 1.1 equivalent of ascorbic acid is added, the nanorods can be centrifuged, rinsed several times with DI water and briefly dried under vacuum. These nanorods have a bilayer coating of strongly adsorbed CTAB molecules which renders them soluble in water.

During the first step the gold seed solution is made according to Murphy/El-Sayed procedure. In the second step 1.6 mL of this freshly prepared (5-10 minutes old) seed solution, which contains residual NaBH₄ is added to the growth solution which is made in a separate flask (all reagents are scaled 100 times). The nanorods start to form in the resulting mixture (Solution of Nanorods) within 10-20 minutes and this Solution of Nanorods is allowed to age for 2-3 hours without any stirring at room temperature. In the third step, 2 grams of gold (III) chloride (HAuCl₄.3H₂O) is dissolved in 1250 mL of DI water to make solution A. In the fourth step, solution B is prepared in a separate flask by dissolving 91 g (grams!) of CTAB in 1250 mL of DI water upon gentle heating (until all CTAB dissolves, temperature should reach 30-35° C.). In the fifth step, solution C is prepared by dissolving 172 mg of silver nitrate in 253 mL of DI water. In the sixth step, that solution C is poured into solution B, and after a gentle mixing, solution A is added to the resulting mixture to produce a solution D, which is in turn is added to the Solution of Nanorods (see above). The seventh step is the aging of the resulting mixture (E) without any stirring at approximately room temperature for 1-4 h. In the eighth step\ 0.5 mL of an aqueous 0.0788 M solution of ascorbic acid (˜2 mol % with respect to Au (III) ions) is added to the mixture E. Next step is aging for 1-4 hrs.

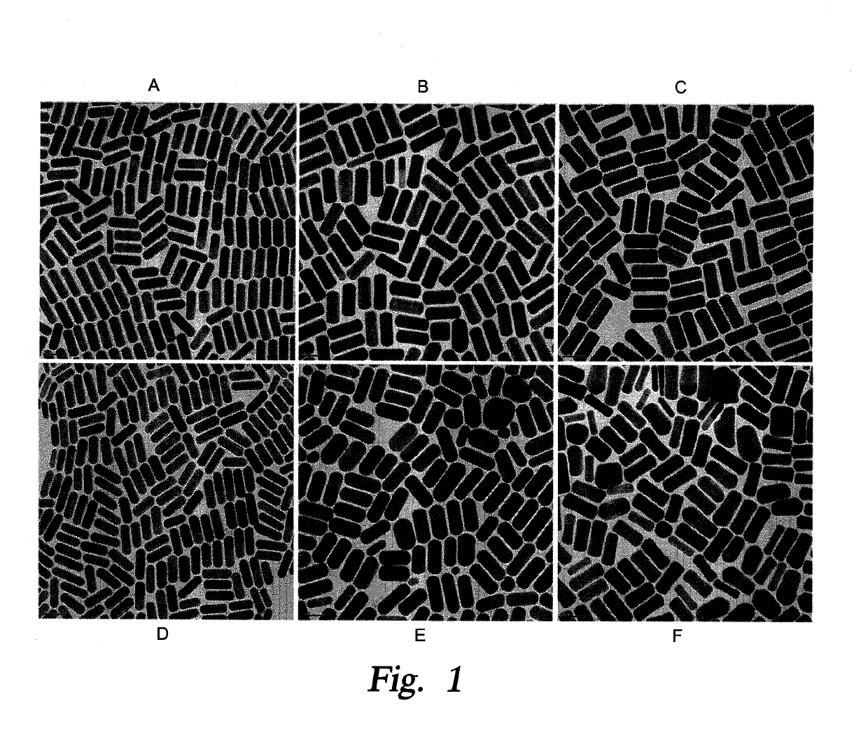

Gold nanorods made by this procedure have been characterized by tunneling electron microscopy TEM. Such images are shown in progression in FIG. 1a-f. FIG. 1a shows the results of slow addition according to the present disclosure of a total of 9 mL of dilute ascorbic acid solution (as an aqueous 0.0788 M solution). For comparison, a fast addition in according to prior art methods is shown in FIG. 1d. FIG. 1b shows the addition of a total volume of 30 mL of dilute ascorbic acid solution, which can be compared with the same 30 mL fast addition in FIG. 1e. The disparity in uniformity is more pronounced with the larger rods being produced. Finally FIG. 1c shows the slow addition according to the present disclosure, of 45 mL of dilute ascorbic acid solution. Again, for comparison, the fast addition of reducing agent is shown in FIG. 1f.

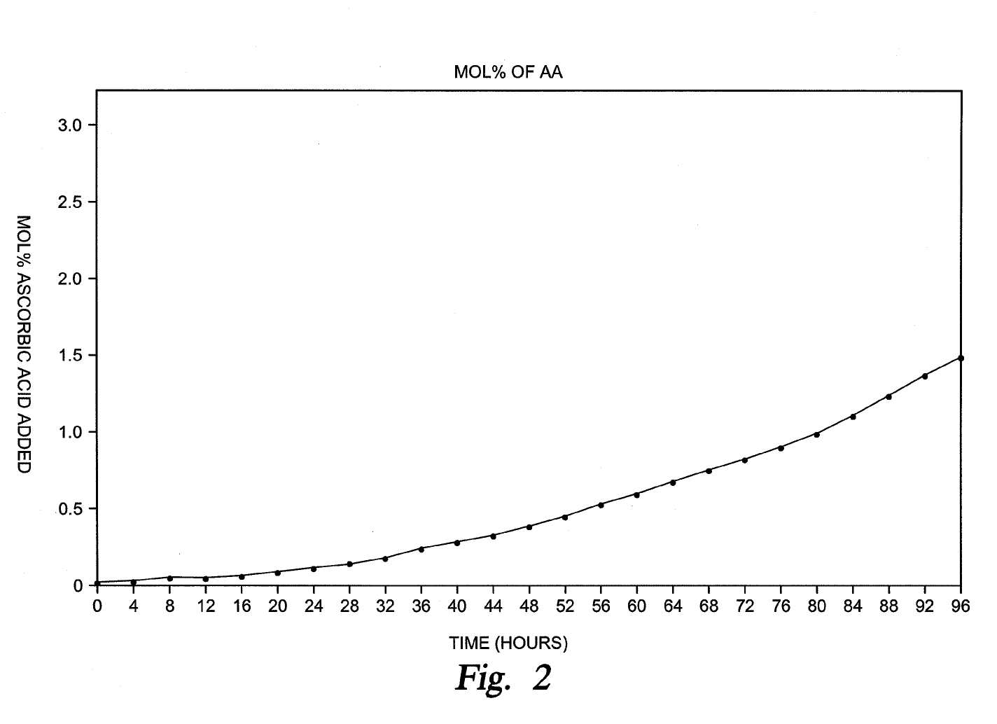

FIG. 2 gives shows in a graphical representation, the nature of the gradual stepwise addition of dilute ascorbic acid in the growth process. The graph shows mol % in the vertical axis versus time in hours on the horizontal axis.

The main advantage of the present procedure is the scale of the synthesis. In general, there are very few methods, which can allow for the synthesis of well-defined gold nanorods. Even the best procedure (Murphy/El-Sayed) can only produce 0.5 mg of the nanorods at a time. An ability to produce 1 gram of this material in one batch using only few liters of the growth solution (˜4 L) and with a near-quantitative yield (both in terms of gold conversion and in terms of rod-like shape versus other shapes of nanocrystals) is a long sought goal, which has not been achieved since the introduction of seed-mediated growth method.

In some embodiments, it may be possible to change the amount of seed used in the process, the average size of the seed particles, their quality and their capping agent. Additionally, one can increase the scale even further in order to produce well-defined nanorods on a true multi-gram scale (increase of the total volume from 4 to 10 or even 20 L). In some embodiments the scale of the synthesis may vary from the known scale of 0.5 mg up to 10 mg. In other embodiments, the gold nanorods are made in gram quantities. In further embodiments the gold nanorods are made in quantities greater than 10 grams. In still further embodiments, the gold nanorods are made in quantities greater than about 100 grams.

Gold nanorods can be used in medicine for imaging, diagnostics and even treatment of cancer. They have very unusual optical properties. Specifically, they absorb light in the infra-red region 700-900 nm and can be easily detected when a laser beam with a similar wavelength (˜800 nm) is shone upon them. This is important because laser light (800 nm) is safe for biological tissue which is transparent to such light (tissue does not absorb it). As a result, gold nanorods can be injected directly into a blood-stream and their location/distribution can be easily determined by using a safe laser light (infrared irradiation).

In addition, the gold nanorods can heat up when the laser light is shone on them. That property results in their ability to increase the temperature locally, for example in the immediate vicinity of a specific target. If that target is a tumor, or an individual cancer cell, it will be destroyed when the laser light is used. That allows one to do non-invasive anti-cancer therapy which is also called photo-thermal therapy with gold nanorods. It can be selective when gold nanorods are coated with specific proteins. Such proteins can deliver gold nanorods primarily to the tumors. Even without specific proteins, however, gold nanorods have a proven tendency to accumulate in the tumors because of the fenestrations in the blood vessels that feed a tumor (normal blood vessels do not have big fenestrations). The fenestrations (holes) of the tumor blood vessels are 5-10 times greater than the size of the gold nanorods described in this application. Because of that they will have the ability to penetrate through the fenestrations, leave the blood stream and permanently accumulate in the tumor. An infra-red light can then be used to heat up the nanorods and destroy the tumor.

Gold nanorods can also have many applications in nanotechnology. They have been used for the preparation of metamaterials, and superb anti-reflecting coatings.

It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed is:

1. A method for making gold nanorods, said method comprising:
adding a seed solution comprising gold nanostructures and NaBH₄ to an aqueous growth solution to form a nanorod solution; and
adding an ascorbic acid solution in a stepwise addition to the nanorod solution.

2. A method for making gold nanorods, said method comprising:
adding a seed solution comprising NaBH₄ to an aqueous growth solution to form a nanorod solution; and
adding an ascorbic acid solution in a stepwise addition to the nanorod solution.

3. The method of any one of claims 1 or 2, wherein the gold nanorods are made in quantities greater than about 10 mg.

4. The method of any one of claims 1 or 2, wherein the gold nanorods are made in gram quantities.

5. The method of any one of claims 1 or 2, wherein the gold nanorods are made in quantities greater than 10 grams.

6. The method of any one of claims 1 or 2, wherein the gold nanorods are made in quantities greater than about 100 grams.

7. The method of any one of claims 1 or 2, wherein there is substantial uniformity in shape and size of the gold nanorods.

8. The method of any one of claims 1 or 2, wherein the aqueous growth solution comprises:
a gold compound selected from the group consisting of gold (III) chloride and hydrogen tetrachloroaurate (III);
a surfactant; and
silver nitrate.

9. The method of claim 8, wherein the surfactant is cetyltrimethylammonium bromide (CTAB).

10. The method of any one of claims 1 or 2, wherein stepwise addition of the ascorbic acid solution comprises addition of aliquots from about 2 to about 35 mol % ascorbic acid, based on gold (III) chloride, until a substantially stoichiometric amount of ascorbic acid, based on gold (III) chloride, has been added;
wherein a period of time from about 1 hour to about 4 hours separates addition of each aliquot.

11. The method of any one of claims 1 or 2, further comprising:
forming gold nanorods that have an aspect ratio from about 1.1 to about 100.

12. The method of any one of claims 1 or 2, further comprising:
forming gold nanorods that have an average diameter in a range from about 5-50 nm.

13. The method of any one of claims 1 or 2, further comprising:
forming gold nanorods that have an average length in a range from about 30-200 nm.

14. The method of any one of claims 1 or 2, further comprising:
forming gold nanorods on a multi-gram scale.

15. Gold nanorods made by the process according to claim 1.

16. The gold nanorods of any one of claims 15 or 19, wherein the gold nanorods have an aspect ratio from about 1.1 to about 100.

17. The gold nanorods of any one of claims 15 or 19, wherein the gold nanorods have an average diameter in a range from about 5-50 nm.

18. The gold nanorods of any one of claims 15 or 19, wherein the gold nanorods have an average length in a range from about 50-200 nm.

19. Gold nanorods made by the process according to claim 2.
